(19) United States
(12) Patent Application Publication
(10) Pub. No.: US 2024/0056294 A1
(43) Pub. Date: Feb. 15, 2024

(54) A NETWORK NODE, A TRANSMITTER AND A RECEIVER FOR QUANTUM KEY DISTRIBUTION OVER AN OPTICAL FIBER NETWORK

(71) Applicants: FUNDACIÓ INSTITUT DE CIÈNCIES FOTÒNIQUES, Barcelona (ES); INSTITUCIÓ CATALANA DE RECERCA I ESTUDIS AVANÇATS, Barcelona (ES)

(72) Inventors: Valerio PRUNERI, Barcelona (ES); Ignacio LÓPEZ GRANDE, Barcelona (ES); Sebastián ECHEVERRY, Barcelona (ES)

(21) Appl. No.: 18/259,058

(22) PCT Filed: Jan. 19, 2021
(86) PCT No.: PCT/EP2021/051021

§ 371 Date: Jun. 22, 2023

(30) Foreign Application Priority Data
Dec. 22, 2020 (EP) 20383141.7

(51) Int. Cl. H04L 9/08; H04B 10/70

(52) U.S. Cl. CPC H04L 9/0855; H04B 10/70

(57) ABSTRACT

A network node configured to operate in an optical fiber network can comprise a quantum key distribution (QKD) communication unit adapted to communicate with another QKD communication unit of at least one other network node of the optical fiber network according to a CV-QKD mode and/or a DV-QKD mode. A control unit can be configured to control the QKD communication unit to operate in at least one of the CV-QKD mode and the DV-QKD mode. The control unit can be configured to switch operation of the QKD communication unit between the CV-QKD mode and the DV-QKD mode.

This innovation has received funding from the European Union's Horizon 2020 research and innovation programme under grant agreement No 820466 and from the European Regional Development Funds (ERDF) allocated to the Programa operatiu FEDER de Catalunya 2014-2020, with the support of the Secretaria d'Universitats i Recerca of the Departament d'Empresa i Coneixement of the Generalitat de Catalunya for emerging technology clusters devoted to the valorization and transfer of research results (QuantumCAT 001-P-001644).

### FIELD OF THE INVENTION

The present invention relates to a network node of a quantum key distribution (QKD). The present invention relates particularly to a network node configured to operate in an optical fiber network, an optical fiber network, a QKD transmitter configured to transmit information in an optical fiber network, and a QKD receiver configured to receive information in an optical fiber network. The present invention further relates to combination of DV-QKD and CV-QKD technologies in such optical fiber network.

### BACKGROUND OF THE INVENTION

In a quantum communication network, information is shared between communicating parties by encoding information in quantum states of light, which typically consists of light pulses containing photon(s). The quantum states/signals may carry one or more than one bit of information, for example, by using properties of the photon, such as its polarization, phase, energy/time, or angular momentum. Quantum key distribution (QKD) is a technology that allows two parties to share cryptographic keys by distributing quantum signals through a communication channel.

The security of QKD relies on the laws of quantum physics, namely the Heisenberg uncertainty principle and non-cloning theorem, which enables the communicating parties to detect the presence of an eavesdropper in the channel. Furthermore, according to the laws of quantum mechanics, measurement of the quantum states by an eavesdropper without prior knowledge of the encoding basis causes an unavoidable change to the quantum state. Therefore, any attempt of an eavesdropper to obtain information of the quantum signals will effectively introduce noise and/or errors that can be detected by the communicating parties.

In a so-called prepare-and-measure QKD, a transmitter (Alice) prepares quantum signals with encoded information according to a specific protocol, and transmits those signals to a receiver (Bob) through an optical channel. Bob performs different measurements on the received quantum signals obtaining data that is correlated to Alice's preparation choices. The correlated data is then post-processed, using a classical communication channel, to extract a secret key. The two main QKD implementations are Discrete-variable QKD (DV-QKD) and Continuous-variable QKD (CV-QKD).

In DV-QKD, the quantum signal consists of single photons with the information to generate a key encoded into a degree of freedom of the photons, such as the polarization, discrete temporal-mode, or phase and the likes

The protocol BB84, proposed in 1984 by Bennet and Brassard, is the first and most widely used DV-QKD protocol. It uses a set of four quantum states that complete two conjugated bases commonly referred to as the Z and X bases. The states of each basis encode the bit value 0 and 1. The protocol begins with Alice preparing a train of single-photons. For each photon, Alice randomly chooses one of the four quantum states and assigns it to the photon by modulating a chosen degree of freedom. Subsequently, the quantum signals are transmitted to Bob, who randomly configures his detection apparatus to measure quantum states of either the X or Z basis.

Every time that Bob chooses the correct basis (i.e. the basis where the received state belongs to), he obtains a bit that is perfectly correlated to Alice choice. Contrarily, when Bob choses the wrong basis, there is no correlation between the bits. Subsequently, a sifting procedure is carried out where the parties publicly announce the chosen bases and discard the data where the bases do not match. Then, Alice and Bob share correlated data that may have noise added by the presence of eavesdropper (Eve) in the channel. To identify a possible eavesdropper, the parties reveal part of the correlated data, which is later excluded, to quantify the noise of the signals. The remaining data is used to extract a secret key by means of error-correction and privacy amplification algorithms.

As mentioned above, DV-QKD uses single photons to encode and transmit information. Single photons are typically obtained by attenuating laser pulses, which has a security problem as the number of photons per pulse follows a Poissonian distribution. Hence, Eve could obtain information from the pulses that have more than one photon (i.e. make use of photon-number-splitting attacks). A countermeasure to this attack is the decoy-state method being used in most of the conventional implementation of DV-QKD, which consists on estimating the number of received quantum states with one photon by distributing additional decoy signals with the same Poissonian distribution but different mean photon number.

Implementations of DV-QKD in fiber links are typically done by using the time-bin degree of freedom. A time-bin state is defined by a photon located in one of two possible temporal modes, known as “early” bin or “late” bin. The quantum states are then encoded by placing a photon in an early bin, a late bin, or in a superposition of early and late bins with a relative phase between them. The superposition states are referred to as the + and −states. Time-bin states are suitable for fiber links because they could be propagated over long distances with low decoherence. In addition to the BB84 protocol, there are other DV-QKD protocols that make use of the time-bin quantum states, for example, coherent-one-way and differential phase shift.

CV-QKD typically uses coherent states of light (weak optical pulses) as quantum signals and the information is encoded in the conjugated quadratures of electromagnetic field. The quadratures are defined corresponding to the amplitude and phase of the signal pulses respectively. The most widely used CV-QKD protocol is the GG02 proposed by Groosham and Grainger in 2002. In GG02, the quadratures of optical signals follow zero-centered Gaussian random distribution, which are obtained by modulating the amplitude and phase of the pulses. In CV-QKD, the signals are measured by means of shot-noise limited coherent detection. This is a major difference compared to DV-QKD technology where more sophisticated and thermally cooled single photon detectors are used. Coherent detection employs a high-intensity reference signal called local oscillator (LO) which is interfered with the received quantum signals to amplify them and retrieve their quadratures values. The coherent detection could use homodyne or heterodyne scheme. In homodyne detection, Bob chooses randomly to measure either X or P quadrature by adding a 90° phase shift to the local oscillator, whereas in heterodyne detection, Bob measures both quadratures simultaneously by splitting the signal in two parts using for instance a 90° optical hybrid.

In early demonstrations of CV-QKD, the local oscillator and the quantum signals were generated from the same laser and both transmitted to Bob by using time multiplexing. This allows for a stable phase relation between the signal and local oscillator. Nevertheless, transmitting the local oscillator over the optical channel could open security problems allowing the eavesdropper to perform calibration attacks. Therefore, in most of the conventional implementations of CV-QKD, the local oscillator is generated locally at Bob with an additional laser, and reference pulses are sent from Alice to Bob to establish a phase relation between the two lasers and to compensate for phase drifts in the optical fiber. Besides GG02, other CV-QKD protocols with discrete modulation have been demonstrated, which allow for simplifying implementation and data post-processing. In these protocols, instead of Gaussian modulated quadratures, a restricted number of quadrature values are used to encode information, similarly to QPSK used in classical commutation.

The conventional QKD implementation mainly corresponds to point-to-point links. However, QKD could also be integrated into optical networks. DV-QKD and CV-QKD technology have specific advantages that can be exploited when integrating QKD into optical networks. For instance, DV-QKD can be more tolerant to channel losses and can be better suited for long distance links. On the other hand, CV-QKD can coexist with intense classical signals as the local oscillator acts as a natural frequency filter. Hence, CV-QKD could be a choice when the fiber link has several co-propagating classical data channels. For instance, coexistence of CV-QKD with a dense-wavelength-division multiplexing (DWDM) data channels has been demonstrated at a higher data rate as compared to DV-QKD. In term of secret key rate, the comparison of CV-QKD and DV-QKD can depend on the optical components and clock rates employed. Nevertheless, CV-QKD is expected to provide higher key rates at short distance as more than one secret bit could be extracted per symbol, whereas DV-QKD would outperform CV-QKD as the distance increases.

Several implementations of DV-QKD and CV-QKD technologies exist in different configurations. For example, as schematically illustrated in FIG. 1, QKD transmitter and receiver can be integrated into a quantum communication network 1000, and the nodes N1101-1108 in such network can be equipped with DV-QKD systems QDV1-QDV7 or CV-QKD systems QCV1-QCV5. Independent links of such conventional QKD networks, illustrated in FIG. 1 with continuous or broken lines, use either CV-QKD or DV-QKD technology. However, existing network and/or node configurations suffer from lack of enhanced reconfigurability to optimize QKD performance depending on characteristics of the link.

Some existing QKD transmitters are available within a DV-QKD scheme for implementing several DV-QKD protocols, such as BB84, coherent-one-way (COW), and differential phase shift (DPS). For example, fiber based QKD transmitter that uses asymmetric a Mach-Zehnder interferometer and a double-pulse generation stage is capable of generating coherent pulses with different phases and relative intensities. Such transmitters can operate in BB84 with time-bin encoding, and also could be used for other DV-QKD protocols such as a six-state BB84. In another example, a modulator-free transmitter for QKD based on direct phase modulation of a semiconductor laser is implemented. However, its operability has been limited to DV-QKD protocols, such as BB84, DPS, and COW.

Moreover, such transmitters are optimized only for DV-QKD. The requirement in term of phase and amplitude modulation to implement CV-QKD protocols are more stringent, since the quantum states may need to be modulated from continuous random distributions, and reference pulses with high intensity compared to the quantum state need to be generated to perform phase recovery. For this reason, it may be required to have the capability of generating pulses with high extinction ratio, and a wide range of amplitude and phase levels (e.g. 1024 voltage levels, for distributions of resolution 10 bits). In addition, CV-QKD with true local oscillator may require two narrow-linewidth (e.g. 20 kHz) lasers that are frequency locked. This constraint on the lasers may cause difficulty in the use of schemes such as injection locking and direct modulation for CV-QKD.

### SUMMARY OF THE INVENTION

In view of the above, it is an object of the present invention to provide an improved network node and/or transmitter/receiver configuration to address one or more of the above-mentioned challenges, disadvantages and/or problems. In other words, an improved and reconfigurable QKD network is needed to ensure interoperability between DV-QKD and CV-QKD systems, and to optimize QKD performance depending on characteristics of the link/network. Furthermore, there is also an advantage in combining CV-QKD and DV-QKD capabilities effectively in a transmitter/receiver of an optical fiber network to realize versatility and flexibility.

Specific embodiment(s) of the present invention disclosed herein relate generally to combining CV-QKD and DV-QKD technologies in an optical fiber network. The present invention further relates to dynamic reconfigurability and switching between CV-QKD and DV-QKD modes to optimize performance depending, for example, on characteristics of the optical fiber link/network (e.g. key rate, communication distance(s), number/presence of co-propagating classical channel, etc). The present invention also discloses a versatile transmitter and/or receiver that can perform communication using both CV-QKD and DV-QKD technologies to optimize the QKD performance of the network.

The present invention, in specific embodiment(s), addresses the above-mentioned object by providing a network node configured to operate in the optical fiber network. The network node comprises: a quantum key distribution (QKD) communication unit configured to communicate with another QKD communication unit of at least one other network node of the optical fiber network according to a continuous-variable (CV)-QKD mode and/or a discrete-variable (DV)-QKD mode; and a control unit configured to control the QKD communication unit to operate in at least one of the CV-QKD mode and the DV-QKD mode, wherein the control unit is configured to switch operation of the QKD communication unit between the CV-QKD mode and the DV-QKD mode.

In this context, the term “network node” refers to a connection node that can receive, create, store or send information along one or more network routes. For example, the network node can be an end node for transmitting information or a redistribution node. The network node can have a software and/or hardware capability to recognize, process and forward/receive information to/from other network nodes. The term “optical fiber network” can be understood as a network of one or more optical fibers for transmitting information from one place to another via optical/light and/or electrical signals. The terms “CV-QKD mode” and “DV-QKD mode” could be understood as modes using “CV-QKD” technology/protocol and “DV-QKD” technology/protocol, respectively.

According to this configuration, as the network node is equipped with the QKD communication unit which can communicate with another QKD communication unit of at least one other network node of the optical fiber network according to at least one of the CV-QKD mode and the DV-QKD mode, the control unit can dynamically switch operation of the QKD communication unit from DV-QKD to CV-QKD or vice versa. Such dynamic reconfigurability would allow to optimize QKD performance depending, for example, on characteristic(s) of the network and/or demand e.g. key rate, communication distance(s), number/presence of co-propagating classical channel, etc. For instance, because of the dynamic switching, the network node can be configured to operate in the DV-QKD mode, due to its higher secret key rate, over a longer-distance link/network, or can be switched to the CV-QKD mode for a short-distance link/network with several co-propagating classical data channels. Thus, in a situation in which depending on the characteristic of a network configuration the performance and functionalities are to be adapted, the inventive network node provides a robust yet simplified way to reconfigure the network.

In specific embodiment(s) of the invention, the QKD communication unit may comprise at least one QKD transmitter configured to operate in at least one of the CV-QKD mode and the DV-QKD mode. By having at least one QKD transmitter capable of operating in both the CV-QKD and the DV-QKD mode with this configuration of the QKD communication unit, the network node can achieve versatile interoperability and reconfigurability so as to optimize the QKD performance of the network.

In specific embodiment(s) of the invention, the control unit may be configured to drive the QKD communication unit with a first predetermined electric signal such that the QKD transmitter operates either in the CV-QKD mode or in the DV-QKD mode. With this, the selection of either using CV-QKD mode or the DV-QKD mode can be implemented via simpler hardware or software configuration.

In specific embodiment(s) of the invention, the QKD transmitter may comprise a modulator unit configured to modulate amplitude and/or phase of light signal emitted by at least one light source, and an electronic circuit may be configured to drive the modulator unit according to the first predetermined electric signal. This provides a simpler but versatile configuration for the transmitter to achieve switchability between the CV-QKD and the DV-QKD mode.

Advantageously, the QKD transmitter may comprise an attenuator configured to attenuate the modulated light signal to a predetermined level and/or set a mean photon number required for the CV-QKD mode or the DV-QKD mode, wherein the electronic circuit may be configured to control the attenuator. In one example, the attenuator can be an electrically-controlled variable optical attenuator, wherein the electronic circuit may further be configured to control the attenuator according to the first predetermined electric signal. The attenuator may be included before the modulator unit or after the modulator unit, but in both cases is included before the CV-QKD or DV-QKD signal(s) are transmitted to the transmission channel.

In specific embodiment(s) of the invention, the control unit may be configured to operate the QKD transmitter simultaneously in the CV-QKD mode and the DV-QKD mode by using any one of time, frequency, space, polarization multiplexing, and any combinations thereof. With such multiplexing, the network node and/or the network can be equipped to perform the DV-QKD and CV-QKD simultaneously, thereby increasing the versatility and provide additional degree of freedom to improve the QKD performance. For instance, the QKD transmitter may allow multiplexing of CV-QKD and DV-QKD signals by using a polarization switch or using different wavelengths from the at least one light/laser source.

In specific embodiment(s) of the invention, the QKD transmitter may combine at least one CV-QKD transmitter and at least one DV-QKD transmitter, the at least one CV-QKD transmitter and the at least one DV-QKD transmitter may share at least one opto-electronic component. As the QKD transmitter shares at least one opto-electronic component of the CV-QKD transmitter and the DV-QKD transmitter, the DV-QKD and CV-QKD transmitters could be combined into one single element such that the single QKD transmitter can be switched to operate either in the CV-QKD mode or in the DV-QKD mode, thereby achieving the versatility and interoperability. This configuration shall also reduce the number of components.

The QKD communication unit may comprise at least one QKD receiver configured to operate in at least one of the CV-QKD mode and the DV-QKD mode. By having at least one QKD receiver capable of operating in both the CV-QKD and DV-QKD mode, the QKD communication unit and thereby the network node can achieve versatile interoperability and reconfigurability so as to optimize the QKD performance of the network.

The control unit may be configured to drive the QKD communication unit with a second predetermined electric signal such that the QKD receiver operates either in the CV-QKD mode or in the DV-QKD mode. With this, the selection of either using CV-QKD mode or the DV-QKD mode can be implemented via simpler hardware or software configuration.

In specific embodiment(s) of the invention, the QKD receiver may comprise a processing/detection unit configured to perform detection of CV-QKD and DV-QKD signals in the CV-QKD mode and the DV-QKD mode respectively, and an electronic circuit configured to drive the processing/detection unit according to the second predetermined electric signal such that the QKD receiver operates either in the CV-QKD mode or in the DV-QKD mode. This provides a simpler but versatile configuration for the receiver to achieve switchability between the CV-QKD and the DV-QKD mode. For instance, the processing/detection unit of the QKD receiver can be a polarization controller, interferometer, balanced detectors, photon detectors configured to perform detection of CV-QKD and DV-QKD signals in the CV-QKD mode and the DV-QKD mode respectively by using a polarizing-beam splitter or a wavelength-division-multiplexer.

In specific embodiment(s) of the invention, the control unit may be configured to operate the QKD receiver simultaneously in the CV-QKD mode and the DV-QKD mode by using any one of time, frequency, space, polarization multiplexing, and any combinations thereof. With such multiplexing, the network node and/or the network can be equipped to perform the DV-QKD and CV-QKD simultaneously, thereby increasing the versatility and provide additional degree of freedom to improve the QKD performance. For instance, the QKD receiver may allow multiplexing of CV-QKD and DV-QKD signals by using the polarizing-beam splitter or the wavelength-division-multiplexer configured to separate CV-QKD and DV-QKD signals for sending them to corresponding detectors.

In specific embodiment(s) of the invention, the QKD receiver may combine at least one CV-QKD receiver and at least one DV-QKD receiver, the at least one CV-QKD receiver and the at least one DV-QKD receiver may share at least one opto-electronic component. As the QKD receiver shares at least one opto-electronic component of the CV-QKD receiver and the DV-QKD receiver, the DV-QKD and CV-QKD receivers could be combined into one single element such that the single QKD receiver can be switched to operate either in the CV-QKD mode or in the DV-QKD mode, thereby achieving the versatility and interoperability. This configuration shall also reduce the number of components.

Advantageously, the CV-QKD mode can be based on at least one CV-QKD protocol and the DV-QKD mode can be based on at least one DV-QKD protocol. For example, the at least one CV-QKD protocol may comprise of a GG02 protocol and a discrete-modulated CV-QKD protocol, wherein the at least one DV-QKD protocol may comprise of a BB84 DV-QKD protocol, a coherent one way DV-QKD protocol, a differential phase shift DV-QKD protocol, a three-states DV-QKD protocol, and a six-states DV-QKD protocol. Accordingly, the inventive network node can operate with different conventional CV-QKD and DV-QKD protocols but suitable for interoperability between CV-QKD and DV-QKD, thereby implementing a flexible and reconfigurable network.

The present invention, in specific embodiment(s), addresses the above-mentioned object by providing an optical fiber network, the optical fiber network comprises one or more network nodes each according to any of the above embodiments/examples. Thus, a dynamically reconfigurable and versatile network with optimized QKD performance can be realized.

Furthermore, each network node can be equipped with at least one CV-QKD transmitter and at least one DV-QKD transmitter. Similarly, network nodes can also be equipped with at least one CV-QKD receiver and at least one DV-QKD receiver.

The present invention, in specific embodiment(s), addresses the above-mentioned object by providing a QKD transmitter configured to transmit information in an optical fiber network. The QKD transmitter comprises a modulator unit configured to modulate amplitude and/or phase of light signal emitted by at least one light source, and an electronic circuit configured to drive the modulator unit according to a predetermined electric signal such that the QKD transmitter operates either in a CV-QKD mode or in a DV-QKD mode. According to QKD, key data can be transmitted from a QKD transmitter to, for example a QKD receiver as quantum information. By having at least one QKD transmitter capable of operating in at least one of the CV-QKD and the DV-QKD mode in the optical fiber network, the network/network node can therefore become versatile by being switchable/configurable between CV-QKD and DV-QKD, thereby providing an efficient way to optimize the QKD performance of the network. Further, by having the electronic circuit, the selection of either using CV-QKD mode or the DV-QKD mode can be implemented via simpler hardware or software configuration.

The QKD transmitter may comprise an attenuator configured to attenuate the modulated light signal to a predetermined level and/or set a mean photon number required for the CV-QKD mode or the DV-QKD mode, wherein the electronic circuit may be configured to control the attenuator. In one example, the attenuator can be an electrically-controlled variable optical attenuator, wherein the electronic circuit may further be configured to control the attenuator according to the predetermined electric signal. The attenuator may be included before the modulator unit or after the modulator unit, but in both cases is included before the CV-QKD or DV-QKD signal(s) are transmitted to the transmission channel. The attenuator can be included to reduce the intensity and/or phase of the modulated light to the predetermined level, or to set the mean photon number to the predetermined level to monitor such parameters in real time in the claimed network and/or to guarantee the security of the claimed network.

Advantageously, the QKD transmitter may be configured to operate simultaneously in the CV-QKD mode and the DV-QKD mode by using any one of time, frequency, space, polarization multiplexing, and any combinations thereof. With such multiplexing, the QKD transmitter can perform the DV-QKD and CV-QKD simultaneously, thereby increasing the versatility and provide additional degree of freedom to improve the QKD performance. For instance, the QKD transmitter may allow multiplexing of CV-QKD and DV-QKD signals by using a polarization switch or using different wavelengths from the at least one light/laser source.

The QKD transmitter may combine at least one CV-QKD transmitter and at least one DV-QKD transmitter, the at least one CV-QKD transmitter and the at least one DV-QKD transmitter may share at least one opto-electronic component. As the QKD transmitter shares at least one opto-electronic component of the CV-QKD transmitter and the DV-QKD transmitter, the DV-QKD and CV-QKD transmitters could be combined into one single element such that the single QKD transmitter can be switched to operate either in the CV-QKD mode or in the DV-QKD mode, thereby achieving the versatility and interoperability.

In specific embodiment(s) of the invention, the QKD transmitter of a network node may be adapted to communicate with corresponding QKD receiver of at least one other network node of the optical fiber network according to the CV-QKD mode and/or the DV-QKD mode. This configuration ensures that the versatility of the QKD transmitter can be translated to the receiver side.

Advantageously, the CV-QKD mode can be based on at least one CV-QKD protocol and the DV-QKD mode can be based on at least one DV-QKD protocol. For example, the at least one CV-QKD protocol may comprise of a GG02 protocol and a discrete-modulated CV-QKD protocol, wherein the at least one DV-QKD protocol may comprise of a BB84 DV-QKD protocol, a coherent one way DV-QKD protocol, a differential phase shift DV-QKD protocol, a three-states DV-QKD protocol, a six-states DV-QKD protocol and a decoy-state DV-QKD protocol. Accordingly, the inventive QKD transmitter can operate with different conventional CV-QKD and DV-QKD protocols but suitable for interoperability between CV-QKD and DV-QKD, thereby implementing a flexible and reconfigurable network.

The present invention, in specific embodiment(s), addresses the above-mentioned object by providing a QKD receiver configured to receive information in the optical fiber network. The QKD receiver comprises a processing/detection unit configured to perform reception and/or detection of CV-QKD and DV-QKD signals in a CV-QKD mode and a DV-QKD mode respectively, and an electronic circuit configured to drive the processing/detection unit according to a predetermined electric signal such that the QKD receiver operates either in the CV-QKD mode or in the DV-QKD mode. By having at least one QKD receiver capable of operating in at least one of the CV-QKD and DV-QKD mode in the optical fiber network, the network/network node can become versatile by being switchable/configurable between CV-QKD and DV-QKD, thereby providing an efficient way to optimize the QKD performance of the network. Further, by having the electronic circuit, the selection of either using CV-QKD mode or the DV-QKD mode can be implemented via simpler hardware or software configuration. For instance, the processing/detection unit of the QKD receiver can be a polarization controller and/or one or more detectors configured to perform processing of and detection of CV-QKD and/or DV-QKD signals in the CV-QKD mode and/or the DV-QKD mode respectively, for example, by using a polarizing-beam splitter or a wavelength-division-multiplexer.

The QKD receiver may be configured to operate simultaneously in the CV-QKD mode and the DV-QKD mode by using any one of time, frequency, space, polarization multiplexing and any combinations thereof. With such multiplexing, the QKD receiver can be equipped to perform the DV-QKD and CV-QKD simultaneously, thereby increasing the versatility and provide additional degree of freedom to improve the QKD performance. For instance, the QKD receiver may allow multiplexing of CV-QKD and DV-QKD signals by using the polarizing-beam splitter or the wavelength-division-multiplexer configured to separate CV-QKD and DV-QKD signals for sending them to corresponding detectors.

In specific embodiment(s) of the invention, the QKD receiver may combine at least one CV-QKD receiver and at least one DV-QKD receiver, the at least one CV-QKD receiver and the at least one DV-QKD receiver may share at least one opto-electronic component. As the QKD receiver shares at least one opto-electronic component of the CV-QKD receiver and the DV-QKD receiver, the DV-QKD and CV-QKD receivers could be combined into one single element such that the single QKD receiver can be switched to operate either in the CV-QKD mode or in the DV-QKD mode, thereby achieving the versatility and interoperability.

In specific embodiment(s) of the invention, the QKD receiver of a network node may be adapted to communicate with corresponding QKD transmitter of at least one other network node of the optical fiber network according to the CV-QKD mode and/or the DV-QKD mode. This configuration ensures that the versatility of the QKD receiver can be translated to the transmitter side.

Advantageously, the CV-QKD mode can be based on at least one CV-QKD protocol and the DV-QKD mode can be based on at least one DV-QKD protocol. For example, the at least one CV-QKD protocol may comprise of a GG02 protocol and a discrete-modulated CV-QKD protocol, wherein the at least one DV-QKD protocol may comprise of a BB84 DV-QKD protocol, a coherent one way DV-QKD protocol, a differential phase shift DV-QKD protocol, a three-states DV-QKD protocol, a six-states DV-QKD protocol and a decoy-state DV-QKD protocol. Accordingly, the inventive QKD receiver can operate with different conventional CV-QKD and DV-QKD protocols but suitable for interoperability between CV-QKD and DV-QKD, thereby implementing a flexible and reconfigurable network.

The present invention, in specific embodiment(s), addresses the above-mentioned object by providing a method of operation of a network node in an optical fiber network, the network node comprising a quantum key distribution (QCD1) communication unit configured to communicate with another QKD communication unit (QCD2-QCD5) of at least one other network node of the optical fiber network according to a continuous-variable (CV)-QKD mode and/or a discrete-variable (DV)-QKD mode, and a control unit configured to control the QKD communication unit (QCD1) to operate in at least one of the CV-QKD mode and the DV-QKD mode, the method comprising a step of switching operation of the QKD communication unit (QCD1) between the CV-QKD mode and the DV-QKD mode. With this method, it is possible to dynamically switch operation of the QKD communication unit from DV-QKD to CV-QKD or vice versa.

Advantageous embodiments of the inventive product(s) and method(s) will be described in the following by referring to the Figures.

### BRIEF DESCRIPTION OF THE DRAWINGS

FIG. 1 illustrates a conventional network 1000 using either CV-QKD or DV-QKD technology.

FIG. 2 illustrates a block diagram of a network node N101, and a network node N102, each in accordance with specific embodiment(s) of the present invention.

FIG. 3 illustrates an optical fiber network 100 having a plurality of network nodes in accordance with specific embodiment(s) of the present invention.

FIG. 4A illustrates a QKD transmitter 400A configured to operate in at least one of a CV-QKD mode and a DV-QKD mode according to specific embodiment(s) of the present invention.

FIG. 4B illustrates a QKD transmitter 400B configured to operate in at least one of a CV-QKD mode and a DV-QKD mode according to specific embodiment(s) of the present invention.

FIG. 4C illustrates an example of a predetermined electric signal for controlling the QKD transmitter 400B shown in FIG. 4B according to specific embodiment(s) of the present invention.

FIG. 4D illustrates a QKD transmitter 400D configured to operate in at least one of a CV-QKD mode and a DV-QKD mode according to specific embodiment(s) of the present invention.

FIG. 4E illustrates a QKD transmitter 400E configured to operate in at least one of a CV-QKD mode and a DV-QKD mode according to specific embodiment(s) of the present invention.

FIG. 4F illustrates a QKD transmitter 400F configured to operate in at least one of a CV-QKD mode and a DV-QKD mode according to specific embodiment(s) of the present invention.

FIG. 4G illustrates a QKD transmitter 400G configured to operate in at least one of a CV-QKD mode and a DV-QKD mode according to specific embodiment(s) of the present invention.

FIG. 5A illustrates a conventional QKD receiver 500A configured to operate either in a CV-QKD mode or a DV-QKD mode.

FIG. 5B illustrates conventional QKD receivers 500B1 and 500B2 each configured to perform time-bin BB84 DV-QKD protocol.

FIG. 5C illustrates a conventional QKD receiver 500C configured to perform GG02 CV-QKD protocol.

FIG. 6 illustrates a QKD receiver 600 configured to operate in at least one of a CV-QKD mode and a DV-QKD mode according to specific embodiment(s) of the present invention.

FIG. 7A illustrates a QKD receiver 700A configured to operate in at least one of a CV-QKD mode and a DV-QKD mode according to specific embodiment(s) of the present invention.

FIG. 7B illustrates a QKD receiver 700B configured to operate in at least one of a CV-QKD mode and a DV-QKD mode according to specific embodiment(s) of the present invention.

### DETAILED DESCRIPTION

In the following, features and advantageous embodiments of the present invention will be described in detail with reference to the Figures.

### Network Node

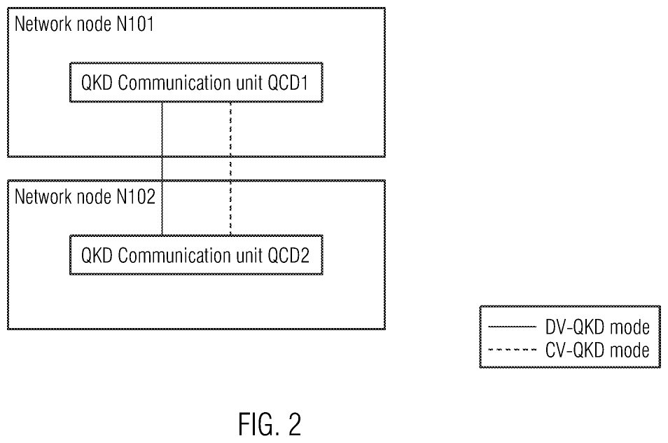

FIG. 2 schematically illustrates a block diagram of a network node N101 according to an embodiment of the present invention. In one specific embodiment, the network node N101 can be part of at least one optical fiber network, for example, for transmitting and/or receiving information such as quantum key information.

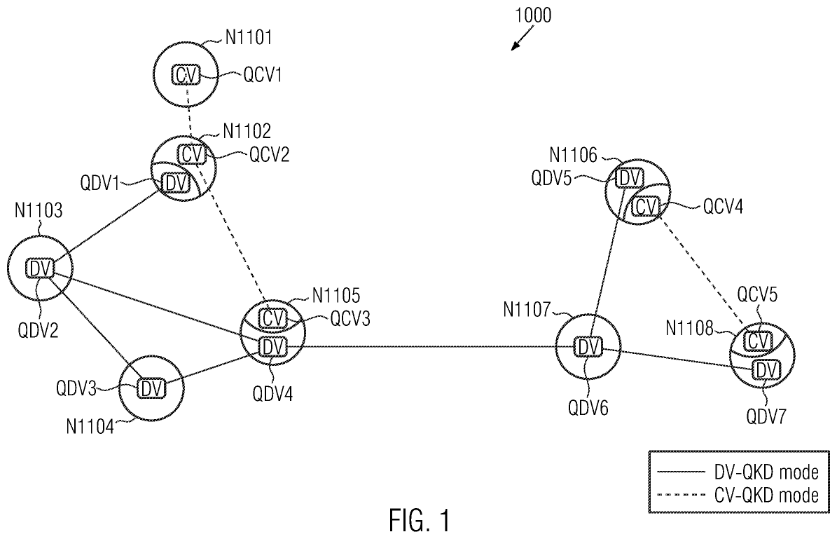

The network node N101 comprises a quantum key distribution (QKD) communication unit QCD1 and a control unit (not shown). The QKD communication unit QCD1 is configured to communicate with another QKD communication unit QCD2 of at least one other network node N102 of the optical fiber network. The QKD communication unit QCD1, in particular, is configured to communicate with the another QKD communication unit QCD2 according to at least one of a continuous-variable (CV)-QKD mode (dotted line in FIG. 1) and a discrete-variable (DV)-QKD mode (continuous line in FIG. 1). The control unit is configured to control the QKD communication unit QCD1 to operate in at least one of the CV-QKD mode and the DV-QKD mode. In particular, the control unit is configured to switch operation of the QKD communication unit QCD1 between the CV-QKD mode and the DV-QKD mode.

The control unit of the node N101 may comprise at least one or more of a microprocessor, a memory, a monitoring means, an electronic means, or a combination thereof. The microprocessor can compute the command(s) to be sent to the QKD communication unit QCD1 and/or its components. Any other processor-based device such as an application specific processor or a microcontroller can also be used in place of microprocessor to perform a similar function. The memory may include a non-transitory computer-readable medium which can store executable instructions to control the QKD communication unit QCD1 to operate in at least one of the CV-QKD mode and the DV-QKD mode. The memory may also contain executable instructions that affect operation of the microprocessor. The monitoring means may be configured to monitor characteristic(s) of the network and/or to receive command from an input interface of the network node N101, or from an external device. In one example, the monitoring means may include sensor(s) to estimate the amount of noise/error or any other specific performance characteristic of the optical fiber link/network. In another example, the input interface may include one or more input devices, buttons or controls to allow dynamic reconfigurability and switching between the CV-QKD mode and the DV-QKD mode.

The CV-QKD mode may refer to the mode in which the respective QKD communication unit is configured to realize CV-QKD implementation. The DV-QKD mode may refer to the mode in which the respective QKD communication unit is configured to realize DV-QKD implementation.

According to this configuration, as the network node N101 is equipped with the QKD communication unit QCD1 which can communicate with the another QKD communication unit QCD2 of at least one other network node N102 of the optical fiber network according to at least one of the CV-QKD mode and the DV-QKD mode, the control unit can dynamically switch operation of the QKD communication unit QCD1 from DV-QKD to CV-QKD mode or vice versa. Such dynamic reconfigurability could allow to optimize QKD performance depending, for example, on characteristic(s) of the network and/or demand e.g. key rate, which can be a secret key rate, which is the number of secret bits per second, communication distance(s), number/presence of co-propagating classical channel, etc. For instance, DV-QKD can provide a higher secret key rate over a longer-distance link/network. In such instances, the control unit can switch the QKD communication unit QCD1 to communicate in the DV-QKD mode. The control unit can switch dynamically from the DV-QKD mode to the CV-QKD for achieving higher secret key rate over a short-distance link/network.

Another possible scenario is that while communicating in the DV-QKD mode, the QKD communication units QCD1 and QCD2 could detect an increment in the noise, which may be due to a higher intensity of classical data channel. In this case, the control unit can switch from the DV-QKD mode to the CV-QKD mode, which can thus co-exist with co-propagating classical signals and allow for a positive key rate. Hence, the QKD communication unit QCD1 can communicate with the QKD communication unit QCD2 demanding a mode switching to the CV-QKD to optimize the secret key rate over a noisy link/network.

An operation of the network mode N101, illustrated in FIG. 2, is described as follows: In the above configuration, the QKD communication unit (QCD1) is switched between the CV-QKD mode and the DV-QKD mode using the control unit. The switching operation can be implemented using hardware and/or software configuration.

### Optical Fiber Network

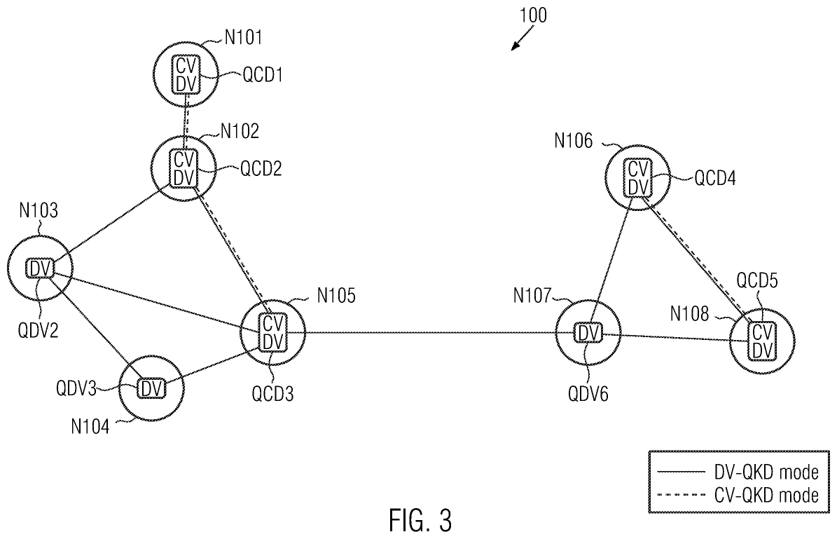

FIG. 3 schematically illustrates an optical fiber network 100, according to an embodiment of the present invention, having a plurality of network nodes N101 to N108. One or more network nodes N101, N102, N105, N106, and N108 of the plurality of network nodes are in accordance with an embodiment of the present invention. Specifically, one or more network nodes N101, N102, N105, N106, and N108 can be equipped with the QKD communication units QCD1-QCD5 which can communicate according to at least one of the CV-QKD mode and the DV-QKD mode. One or more nodes N103, N104, N107 can be equipped with the QKD communication units QDV2, QDV3 and QDV6 which can communicate according to the DV-QKD mode only. Similarly, there can be one or more additional nodes (not shown) which can communicate according to the CV-QKD mode only.

For instance, the network node N101 is configured to communicate with the network node N102 in at least one of the CV-QKD mode (shown as dotted line in FIG. 3) and the DV-QKD mode (shown as continuous line in FIG. 3). The network node N102 can communicate with the other network nodes N101, N103, N104 and N105. The communication can be in at least one of the CV-QKD mode and the DV-QKD mode depending on the configurability of the other network nodes N101, N103, N104 and N105.

For example, the network node N101 or N105 is configured to operate either in the CV-QKD mode or in the DV-QKD mode. Accordingly, the communication between the network node N102 and the network node N101 or N105 can be switched between the CV-QKD mode and the DV-QKD mode for achieving the optimized QKD performance. The network node N102 or N105 communicates with the network node N103 or N104, respectively, via DV-QKD mode. The network nodes N103 and N104 communicate with each other via DV-QKD mode.

Due to the combination of CV-QKD and DV-QKD technologies in the optical fiber network 100, the present invention allows dynamic reconfigurability and switching between CV-QKD and DV-QKD mode to optimize QKD performance of the optical fiber network.

The present invention is not limited thereto. The optical fiber network can have any number of network nodes. All or some of the network nodes can be reconfigurable to switch between CV-QKD mode and DV-QKD mode. The network nodes can communicate with each other via one or more waveguides such as optical communication channel, optical fibers and the likes.

In an embodiment, each of the network nodes of the present invention can include at least one transmitter and/or at least one receiver, as part of the respective QKD communication unit, for communicating with other network nodes of the optical fiber network. The transmitter and receiver can be configured to exchange CV-QKD signal and/or DV-QKD signal, and thus are configured for QKD, and hence have been termed as QKD transmitter and QKD receiver, respectively.

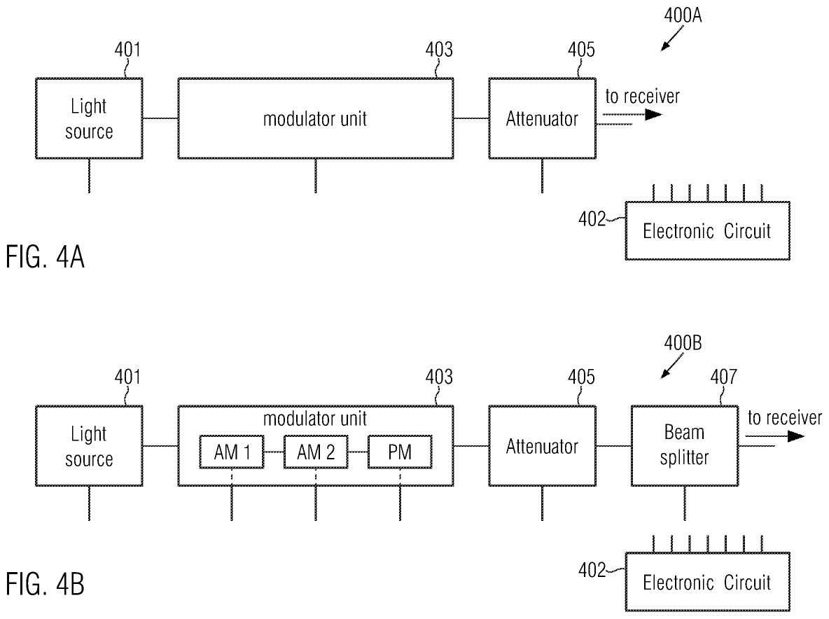

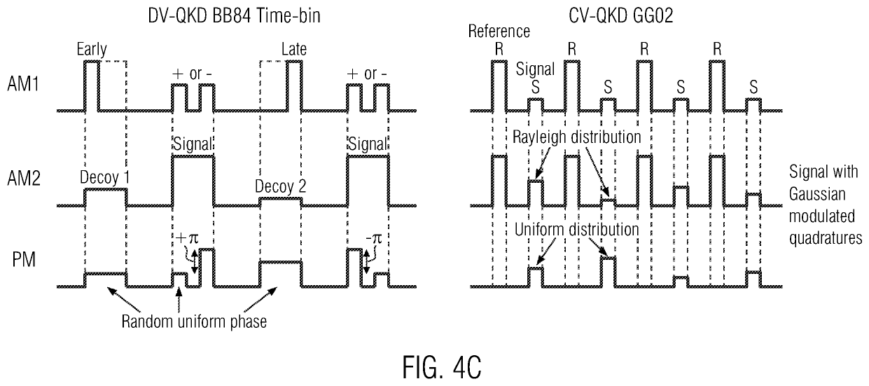

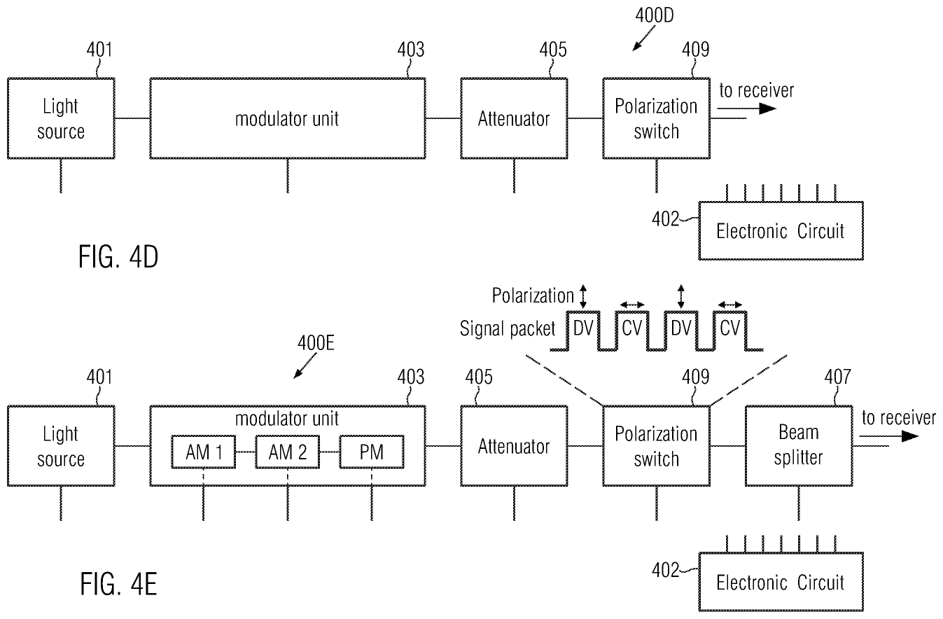

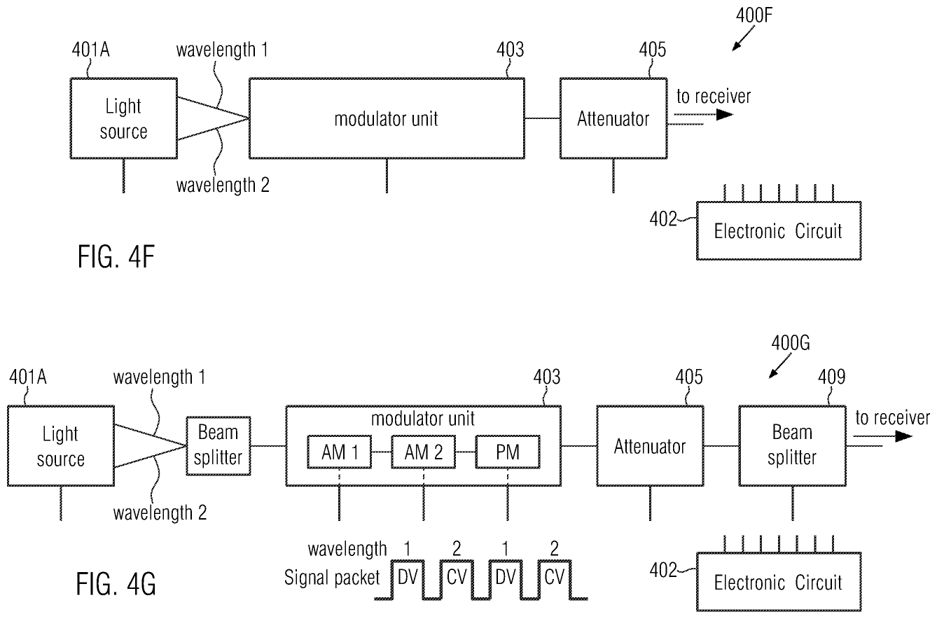

The QKD communication unit may comprise at least one QKD transmitter and/or at least one QKD receiver configured to operate in at least one of the CV-QKD mode and the DV-QKD mode. In the following, QKD transmitter and QKD receiver will be described using FIGS. 4A-7B.

### QKD Transmitter

FIG. 4A illustrates a block diagram of a QKD transmitter 400A according to another embodiment of the invention. The QKD transmitter 400A is configured to operate in at least one of the CV-QKD mode and the DV-QKD mode. By having the QKD transmitter 400A capable of operating in both the CV-QKD and the DV-QKD mode, the network node can achieve versatile interoperability and reconfigurability so as to optimize the QKD performance of the network 100 disclosed previously. The QKD transmitter is configured to transmit the CV-QKD and/or DV-QKD signals to the receiver.

In an embodiment of the invention, the QKD transmitter 400A may combine at least one CV-QKD transmitter and at least one DV-QKD transmitter into a single element. In a specific example, the at least one CV-QKD transmitter and the at least one DV-QKD transmitter may share at least one opto-electronic component. As the QKD transmitter shares at least one opto-electronic component of the CV-QKD transmitter and the DV-QKD transmitter, the DV-QKD and CV-QKD transmitters could be combined into one single element such that the single QKD transmitter can be switched to operate either in the CV-QKD mode or in the DV-QKD mode, thereby achieving the versatility and interoperability. This configuration shall also reduce the number of components.

The QKD transmitter 400A comprises an electronic circuit 402 and a modulator unit 403. At least one light source 401 can be provided to be part of the QKD transmitter 400A or external to the QKD transmitter 400A.

The at least one light source 401 is configured to emit light signal. For example, the light source can be a laser light source, in particular, a continuous wave (CW) laser light source. Alternatively, the light source can be a pulsed laser light source. The light source can be a tunable laser source, whereby the wavelength of the lasers could be tuned to allow, for example, for quantum communication in a specific channel of the band being used (e.g. C-band).

The modulator unit 403 may receive the light signal emitted by the at least one light source 401. The modulator unit 403 is configured to modulate amplitude and/or phase of the received light signal. The modulator unit 403 may comprise one or more amplitude modulators for modulating the amplitude of the light signal and/or at least one phase modulator for modulating the phase of the light signal, respectively. The amplitude and/or phase modulator may comprise one or more optical and/or electronic component(s). For example, the amplitude and/or phase modulator may comprise at least one material which exhibits electro-optic effect such that the respective amplitude and/or phase modulation can be achieved by controlling electric field in the material. The amplitude modulator can preferably have a predetermined extinction ratio (e.g. >20 dB) to reduce the background noise. In case of CV-QKD with Gaussian modulation, the phase and/or amplitude modulators could have a predetermined resolution and dynamic range to obtain a desired approximation of continuous modulation of phase and amplitude. The one or more optical and/or electronic component(s) of the modulators can be the shared one or more opto-electronic components of the corresponding CV-QKD transmitter and the DV-QKD transmitter.

The electronic circuit 402 is configured to control the modulator unit 403. In particular, the electronic circuit 402 is configured to drive the modulator unit 403 according to a first predetermined electric signal in such a way that the QKD transmitter 400A operates either in the CV-QKD mode or in the DV-QKD. The electronic unit 402 can allow selecting the CV-QKD mode or the DV-QKD mode by setting the first predetermined electric signal that drive the modulator unit 402. The electronic circuit 402 can be a hardware and/or a software element. With this, the selection of either using the CV-QKD mode or the DV-QKD mode can be implemented via simpler hardware and/or software configuration.

The first predetermined electric signal of the electronic circuit 402 can be configured to drive the modulator unit 403. In particular, the components of the modulator unit 403, such as one or more shared optical-electrical component(s) of the amplitude and/or phase modulator is(are) configured to be driven by the first predetermined electric signal so as to select one of the CV-QKD mode and the DV-QKD mode as the mode of operation of the QKD transmitter 400A. In an example, the first predetermined electric signal can determine whether the communication mode is the CV-QKD mode or the DV-QKD mode.

Examples of the electronic circuit 402 include, but not limited to, an electronic switch, a field-programmable-gate-array and may also be combined with one or more digital-to-analog converters. The electronic circuit 402 may be configured to control the laser parameters of the light source 401, such as wavelength, frequency, power and the likes. Additionally, the electronic circuit 402 may be configured to monitor, using one or more analog-to-digital converters, the operation of the light source 401 and/or optical-electrical components of the modulator unit 403. In an embodiment, the electronic circuit 402 can be controlled by a software.

According to another embodiment of the invention as illustrated in FIG. 4A, the QKD transmitter 400A may further comprise an attenuator 405 configured to attenuate the modulated light signal to a predetermined level and/or to set a mean photon number required for the CV-QKD mode or the DV-QKD mode. The electronic circuit 402 may be configured to control the attenuator 405. The attenuator 405 could be driven by the first predetermined electric signal. For example, for a given communication mode, the attenuation as well as the first predetermined electrical signal can be fixed. In one example, the attenuator 405 can be a fixed optical attenuator or a variable optical attenuator. The position of the attenuator 405 is not limited. For example, the attenuator 405 can be included before the modulator unit 403 or after the modulator unit 403. The attenuator 405 can be included to reduce the intensity and/or phase of the modulated light to the predetermined level, or to set the mean photon number to the predetermined level to monitor such parameters in real time in the optical fiber network and/or to guarantee the security of the optical fiber network. The attenuator 405 may comprise one or more optical and/or electronic component(s). The one or more optical and/or electronic component(s) of the attenuator 405 can be the shared one or more opto-electronic components of the corresponding CV-QKD attenuator and the DV-QKD attenuator. The electronic circuit 402 can be configured to allow selecting the CV-QKD mode or the DV-QKD mode by setting the first predetermined electric signal that drive the attenuator 405 and/or the shared one or more opto-electronic components of the attenuator 405.

FIG. 4B illustrates a QKD transmitter 400B which is a specific implementation of the embodiment/block diagram of the QKD transmitter 400A shown in FIG. 4A. In this specific implementation, the QKD transmitter 400B may perform DV-QKD and CV-QKD according to DV-QKD BB84 time-bin protocol and CV-QKD GG02 protocol, respectively. The modulator unit 403 may comprise two electro-optic amplitude modulators AM1, AM2 for modulating amplitude of the light signal emitted by the light source 401, which in this specific implementation is a continuous wave laser, and an electro-optic phase modulator PM1 for modulating phase of the emitted light signal. Subsequently, the attenuator 405, which in this specific implementation is an electrically-controlled variable optical attenuator, may attenuate the modulated light signal to the predetermined level and/or to set the mean photon number required for the CV-QKD mode or the DV-QKD mode.

The specific implementation can further include a beam-splitter 407. The beam splitter 407 can be configured to split the modulated light signals, so that one part of the split modulated light signals can be sent for further processing such as measurement of mean photon number and the likes, and the remaining part can be sent to the receiver (described later).

The electronic circuit 402 is configured to drive at least of the laser light source 401, the one or more modulators AM1, AM2, PM1, and the attenuator 405. In particular, one or more of these components can be driven according to the first predetermined electric signal in such a way that the QKD transmitter 400B can operate either in the CV-QKD mode or in the DV-QKD mode.

FIG. 4C illustrates an example of the predetermined electric signal for driving the one or more electro-optic modulators of the QKD transmitter 400B shown in FIG. 4B in order to implement DV-QKD BB84 time-bin protocol and CV-QKD GG02 protocol according to the DV-QKD mode and the CV-QKD mode respectively. In other words, the predetermined electric signal may comprise one or more electrical signals to drive the one or more electro-optic modulators such that the QKD transmitter 400B operates either in the CV-QKD mode or in the DV-QKD mode. In this example, the electrical signals correspond to the time-bin BB84 DV-QKD protocol (FIG. 4C, left) and GG02 CV-QKD protocol with true local oscillator (FIG. 4C, right). In describing the FIG. 4C, the relevant parts of the background section of the invention are not repeated but incorporated here by reference.

For the time-bin BB84 protocol as shown in FIG. 4C (left), the first amplitude modulator 403, AM1 generates pulses with intensities according to the four quantum states; the early and late states from the Z basis, and the two superposition states + and − from the X basis, which corresponds to two pulses with equal intensity. Subsequently, the second amplitude modulator 403, AM2 carries out the decoy state method. For instance, two decoys are implemented by adjusting the intensity levels of the states as depicted in FIG. 4C (left). The mean photon number of signal and decoy states are adjusted by using the second amplitude modulator 403, AM2 and the attenuator 405, respectively. For example, signal pulses with a mean photon number of 1 (i.e. one photon per pulse on average), and decoy states with mean photon number of 0.1 and 0.01 could be used. Finally, the phase modulator 403, PM1 is used to set the phase difference of +π and −π for the states of the X basis and also, may be, to add a uniformly distributed random phase between symbols as required by security proof of the protocol.

The electrical signals used to operate the QKD transmitter 400B for the GG02 CV-QKD protocol are shown in FIG. 4C (right). In this example, the first amplitude modulator 403, AM1 generates pulses R, S with two different amplitudes, as reference and signal pulses, respectively. The reference pulses can be interleaved between the quantum signals, which consists of optical pulses with Gaussian-modulated quadratures X, P. Gaussian-modulated quadratures are obtained by using the second amplitude modulator 403, AM2 to modulate the amplitude of the signals according to Rayleigh random distribution, and the phase modulator 403, PM1 to modulate the phase according to uniform random distribution. The attenuator 405 can be used to set the modulation variance of the signals (e.g. equal to twice the mean photon number) to a value that can maximize the secret key rate. In one embodiment, the amplitude of the reference pulses can typically be higher than the amplitude of the signal pulses so as to obtain accurate phase recovery.

FIG. 4D illustrates a block diagram of a QKD transmitter 400D according to another embodiment of the present invention. The QKD transmitter 400D includes all of the components, details and functionality of the QKD transmitter 400A shown in FIG. 4A. The QKD transmitter 400D further includes a polarization switch 409. The polarization switch 409 facilitates the QKD transmitter 400D to operate simultaneously in the CV-QKD mode and the DV-QKD mode, for example, by using any one of time, frequency, space, polarization multiplexing, and any combinations thereof. The QKD transmitter 400D could operate by sending multiplexed CV-QKD and DV-QKD signals to the receiver (described later). A QKD transmitter 400E, illustrated in FIG. 4E, is a specific example implementation of the QKD transmitter 400D. In this implementation, the polarization switch 409 can be configured to time-multiplex the CV-QKD and DV-QKD signals with orthogonal polarization such that the QKD transmitter 400E can send time-multiplexed packets of CV-QKD and DV-QKD signals to the receiver.

FIG. 4F illustrates a block diagram of a QKD transmitter 400F according to another embodiment of the present invention. The QKD transmitter 400F includes all of the components, details and functionality of the QKD transmitter 400A shown in FIG. 4A. In the QKD transmitter 400F, the light source 401A is configured to operate at two different wavelengths/frequencies, one for the DV-QKD mode, and the other for the CV-QD mode, thereby achieving wavelength or frequency-multiplexing. The light source 401A can be one single light source, such as for e.g., a tunable laser source, configured to operate using two different wavelengths/frequencies, or two individual light sources each operating at a given wavelength/frequency same or different from each other. The light source 401A can facilitate the QKD transmitter 400F to operate simultaneously in the CV-QKD mode and the DV-QKD mode, for example, by using wavelength or frequency multiplexing, and any combinations thereof. A QKD transmitter 400G, illustrated in FIG. 4G, is a specific example implementation of the QKD transmitter 400F. In this implementation, the QKD transmitter 400G can wavelength or frequency-multiplex the CV-QKD and DV-QKD signals and send wavelength or frequency-multiplexed packets of CV-QKD and DV-QKD signals to the receiver.

The time-bin BB84 protocol and GG02 CV-QKD protocol mentioned above are just one example of a DV-QKD and a CV-QKD protocol, respectively, that can be performed with the QKD transmitter 400A-400G proposed in FIGS. 4A-4G. The present invention, however, is not limited thereto. The predetermined electric signal sent by the electronic circuit 402 can be modified to carry out any other protocols such as a discrete-modulated CV-QKD protocol, a coherent one way DV-QKD protocol, a differential phase shift DV-QKD protocol, a three-states DV-QKD protocol, a six-states DV-QKD protocol and a decoy-state DV-QKD protocol, and the likes.

### QKD Receiver

The QKD receiver is configured to receive QKD signals from the QKD transmitter. Conventional QKD receiver is configured to receive either the CV-QKD signal or the DV-QKD signal from the respective transmitter.

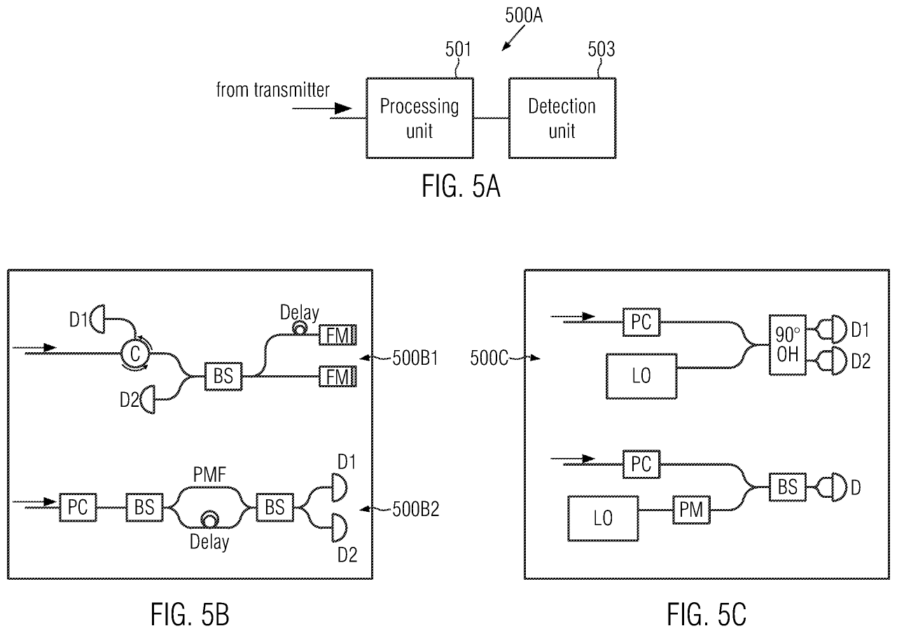

The conventional QKD receiver 500A, illustrated in FIG. 5A, typically includes a processing unit 501 for receiving the CV or DV-QKD signals from the respective CV or DV-QKD transmitter and/or for processing the received QKD signals, and a detection unit 503 for detecting the received QKD signals. The processing unit 501 can include one or more opto-electronic components. The one or more opto-electronic components of the processing unit 501 can include but not limited to any combination of an interferometer such as a balanced/unbalanced Michelson interferometer or a balanced/unbalanced Mach-Zehnder interferometer, one or more beam splitters, a polarization member such as a polarization-maintaining optical fiber (PMF), a polarization controller, one or more modulators/demodulators, a local oscillator and the likes. The detecting unit 503 can also include but not limited to one or more opto-electronic components such as one or more single-photon detectors, a heterodyne detector, a homodyne detector and the likes.

FIG. 5B-5E illustrate an example of such conventional DV-QKD and CV-QKD receivers used for DV-QKD mode and CV-QKD mode, respectively.

FIG. 5B, upper drawing illustrate a conventional receiver 500B1 typically used for performing time-bin BB84 DV-QKD protocol. The receiver 500B1 includes an unbalanced interferometer with two arms, a beam-splitter BS, and two Faraday Mirrors FMs disposed at the end of each interferometer arm so that the Faraday Mirrors FMs can render the interferometer polarization-independent. A fiber delay equal to the time separation between the ‘early’ and ‘late’ temporal modes, of FIG. 4C, can be added to one arm of the interferometer. The receiver 500B1 further includes at least two detectors D1, D2, and a circulator C for splitting the signals for detection by the respective detectors D1, D2 such that the interferometer can use the same port for input and output.

Alternatively, FIG. 5B, lower drawing illustrate a receiver 500B2 typically used for performing time-bin BB84 DV-QKD protocol. The receiver 500B2 includes an unbalanced interferometer with two arms, a beam-splitter BS, a polarization-maintaining member PMF added to both arms of the interferometer, and a polarization controller PC at the input side of the receiver so as to align the polarization of the received QKD signal with the axis of the polarization-maintaining member PMF. A fiber delay equal to the time separation between the ‘early’ and ‘late’ temporal modes, of FIG. 4C, can be added to one arm of the interferometer. The receiver 500B1 further includes at least two detectors D1, D2, and a further beam splitter BS for splitting the signals for detection by the respective detectors D1, D2.

FIG. 5C illustrate a conventional receiver 500C typically used for performing GG02 CV-QKD protocol. The receiver 500C is configured to interfere incoming signals from the transmitter with a local oscillator so as to allow retrieval of the signal quadrature values. The receiver 500C includes a polarization controller PC for aligning the polarization of the signal and the local oscillator LO such that the interference can be maximized. The receiver 500C, illustrated in FIG. 5C upper drawing, includes a heterodyne detector by which the quadratures X and P can be detected simultaneously by using a 90° optical hybrid OH and two detectors D1, D2. Alternatively, the receiver 500C, illustrated in FIG. 5C lower drawing, can include a homodyne detector by which the quadratures X and P can be detected, by a single detector D, one at a time by randomly changing the phase of the local oscillator between 0 and π using a phase modulator PM.

In an embodiment of the present invention, any conventionally known DV-QKD and/or CV-QKD receivers, such as the ones illustrated in FIGS. 5A-5C, can be used in combination with the QKD transmitters of the invention illustrated, in FIGS. 4A-4G, in DV-QKD and/or CV-QKD communication in the optical fiber network, respectively.

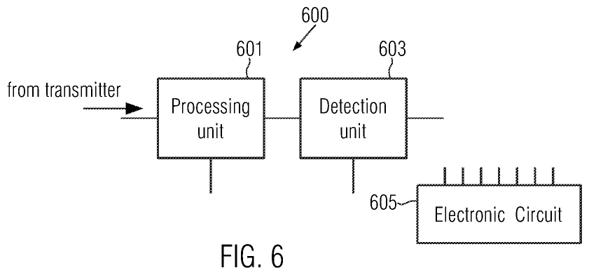

A QKD receiver 600 according to an embodiment of the invention is described with reference to FIG. 6. The QKD receiver 600 includes a processing unit 601 configured to receive CV and/or DV-QKD signals, for example, from the conventional CV and/or DV-QKD transmitter, or the QKD transmitter according to the invention, and/or configured to process the received QKD signals, and a detection unit 603 configured to detect the received QKD signals. The processing unit 601 and the detecting unit 603 can include the same components as that of the receiver 500A.

The QKD receiver 600 further includes an electronic circuit 605 configured to control the processing unit 601 and/or the detection unit 603. In particular, the electronic circuit 605 is configured to drive the processing unit 601 and/or the detection unit 603, for example according to a second predetermined electric signal, in such a way that the QKD receiver 600 operates either in the CV-QKD mode or in the DV-QKD. The electronic unit 605 can allow selecting the CV-QKD mode or the DV-QKD mode by setting the second predetermined electric signal that drive the processing unit 601 and/or the detection unit 603. The electronic circuit 605 can be a hardware and/or a software element. Examples of the electronic circuit 605 include, but not limited to, an electronic switch, a polarizing-beam splitter (PBS), a wavelength-division-multiplexer (WDM), a polarization controller and the likes. In an embodiment, the electronic circuit 605 can be controlled by a software.

The second predetermined electric signal of the electronic circuit 605 can be configured to drive the components of the processing unit 601 and/or the detection unit 603, in particular the one or more opto-electronic components of the processing unit 601 and/or the detection unit 603 so as to select one of the CV-QKD mode and the DV-QKD mode as the mode of operation of the QKD receiver 600. The second predetermined electric signal can be any form of signal but is a signal to the processing unit and/or the detecting unit to switch the operation from CV-QKD to DV-QKD and vice versa.

The QKD receiver 600 is thus configured to operate in at least one of the CV-QKD mode and the DV-QKD mode, thereby versatile interoperability, reconfigurability and switchability can be achieved, and the the QKD performance can be optimized.

In an embodiment, the one or more opto-electronic component(s) of the QKD receiver can be the one or more opto-electronic components shared by the conventional CV-QKD receiver and the DV-QKD receiver. Similarly to the QKD transmitter of the invention, the electronic circuit 605 of the QKD receiver is configured to perform detection of DV and/or CV signals by suitably between the DV-QKD mode and the CV-QKD mode.

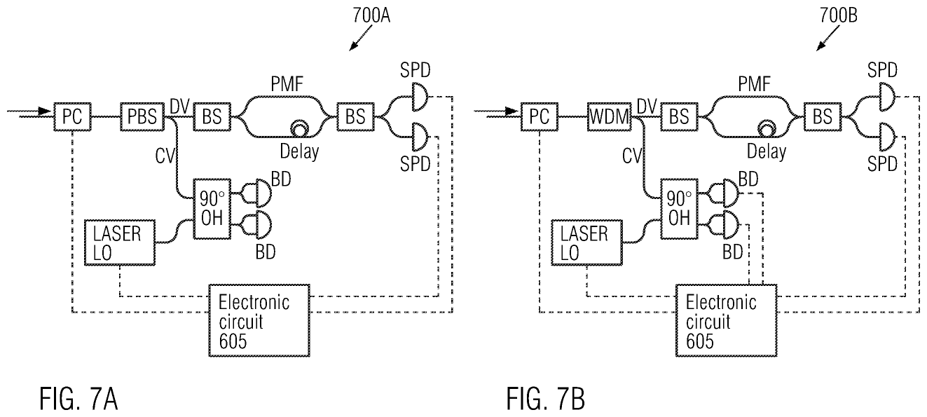

FIG. 7A illustrates a QKD receiver 700A according to a specific implementation in an embodiment of the present invention. The QKD receiver 700A combines the components of the time-bin BB84 DV-QKD receiver 500B2 of FIG. 5B and the components of the GG02 CV-QKD receiver 500C of FIG. 5C (upper drawing) and which, in this embodiment, are configured to be controlled by the electronic circuit 605 of FIG. 6. The polarization controller PC is controlled by the electronic circuit 605 such that the QKD receiver 700A can be operated in at least one of the DV-QKD mode and the CV-QKD mode. In this embodiment, the QKD receiver 700A is provided with a polarizing-beam splitter PBS configured to be controlled by the polarization controller PC. The electronic circuit 605 is configured to control the polarization controller PC such that the polarization controller PC is configured to send signal to the polarizing-beam splitter PBS so that the components of the DV or CV-QKD receiver is operated for receiving the respective QKD signal, for example, from the QKD transmitter of the present invention.

FIG. 7B illustrates an alternative QKD receiver 700B according to another specific implementation in an embodiment of the present invention. The QKD receiver 700B is different from the QKD receiver 700A in that the polarizing-beam splitter PBS is replaced by a wavelength-division-multiplexer WDM. The QKD receiver 700B can be used in instances where the light source 401A of the QKD transmitter 400F or 400G operates at two different wavelengths/frequencies, one for the DV-QKD mode, and the other for the CV-QD mode, like, for example, in the embodiment of FIG. 4E. In operation, the QKD transmitter 400C can wavelength or frequency-multiplex the CV-QKD and DV-QKD signals and send wavelength or frequency-multiplexed packets of CV-QKD and DV-QKD signals to the QKD receiver 700B. In response to the electronic circuit 605, the wavelength-division-multiplexers WDM is configured to separate the DV and CV signals and send them to the corresponding detectors. With this multiplex configuration, DV-QKD mode and the CV-QKD mode can be simultaneously performed by the QKD receiver 700B.

The time-bin BB84 protocol and GG02 CV-QKD protocol mentioned above are just one example of a DV-QKD and a CV-QKD protocol, respectively, that can be performed with the QKD receiver 600-700B proposed in FIGS. 6-7B. The present invention, however, is not limited thereto. The predetermined electric signal sent by the electronic circuit 605 can be modified to carry out any other protocols such as a discrete-modulated CV-QKD protocol, a coherent one way DV-QKD protocol, a differential phase shift DV-QKD protocol, a three-states DV-QKD protocol, a six-states DV-QKD protocol and a decoy-state DV-QKD protocol, and the likes.

The embodiments of present invention provide a network node, an optical network, a QKD transmitter, a QKD receiver, and a method of operation of the network node according to which operation between the DV-QKD and CV-QKD mode can be dynamically switched, thereby it is possible to realize a versatile, and robust reconfiguration of an optical fiber network and interoperability.

1. A network node configured to operate in an optical fiber network, the network node comprising:
a quantum key distribution (QKD) communication unit configured to communicate with another QKD communication unit of at least one other network node of the optical fiber network according to a continuous-variable (CV)-QKD mode and/or a discrete-variable (DV)-QKD mode; and
a control unit configured to control the QKD communication unit to operate in at least one of the CV-QKD mode and the DV-QKD mode,
wherein the control unit is configured to switch operation of the QKD communication unit between the CV-QKD mode and the DV-QKD mode.

2. The network node of claim 1, wherein the QKD communication unit comprises at least one QKD transmitter configured to operate in at least one of the CV-QKD mode and the DV-QKD mode.

3. The network node of claim 2, wherein the control unit is configured to drive the QKD communication unit with a first predetermined electric signal such that the QKD transmitter operates either in the CV-QKD mode or in the DV-QKD mode.

4. The network node of claim 3, wherein the QKD transmitter comprises:
a modulator unit configured to modulate amplitude and/or phase of light signal emitted by at least one light source; and
an electronic circuit configured to drive the modulator unit according to the first predetermined electric signal.

5. The network node of claim 4, wherein the QKD transmitter comprises an attenuator configured to attenuate the modulated light signal to a predetermined level and/or set a mean photon number required for the CV-QKD mode or the DV-QKD mode, wherein the electronic circuit is configured to control the attenuator.

6. The network node of claim 2, wherein the control unit is configured to operate the QKD transmitter simultaneously in the CV-QKD mode and the DV-QKD mode by using any one of time, frequency, space, polarization multiplexing, and any combinations thereof.

7. The network node of claim 2, wherein the QKD transmitter combines at least one CV-QKD transmitter and at least one DV-QKD transmitter, the at least one CV-QKD transmitter and the at least one DV-QKD transmitter share at least one opto-electronic component.

8. The network node of claim 1, wherein the QKD communication unit comprises at least one QKD receiver configured to operate in at least one of the CV-QKD mode and the DV-QKD mode.

9. The network node of claim 8, wherein the control unit is configured to drive the QKD communication unit with a second predetermined electric signal such that the at least one QKD receiver operates either in the CV-QKD mode or in the DV-QKD mode.

10. The network node of claim 9, wherein the at least one QKD receiver comprises:
a processing/detection unit configured to perform detection of CV-QKD and DV-QKD signals in the CV-QKD mode and the DV-QKD mode respectively; and
an electronic circuit configured to drive the processing/detection unit according to the second predetermined electric signal.

11. The network node of claim 8, wherein the control unit is configured to operate the at least one QKD receiver simultaneously in the CV-QKD mode and the DV-QKD mode by using any one of time, frequency, space, polarization multiplexing, and any combinations thereof.

12. The network node of claim 8, wherein the QKD receiver combines at least one CV-QKD receiver and at least one DV-QKD receiver, the at least one CV-QKD receiver and the at least one DV-QKD receiver share at least one opto-electronic component.

13. The network node of claim 1, wherein the CV-QKD mode is based on at least one CV-QKD protocol and the DV-QKD mode is based on at least one DV-QKD protocol.

14. The network node of claim 13, wherein the at least one CV-QKD protocol comprises of a GG02 protocol and a discrete-modulated CV-QKD protocol, wherein the at least one DV-QKD protocol comprises of a BB84 DV-QKD protocol, a coherent one way DV-QKD protocol, a differential phase shift DV-QKD protocol, a three-states DV-QKD protocol, a six-states DV-QKD protocol and a decoy-state DV-QKD protocol.

15. An optical fiber network comprising one or more network nodes each according to claim 1.

16. A QKD transmitter configured to transmit information in an optical fiber network, the QKD transmitter comprising:
a modulator unit configured to modulate amplitude and/or phase of light signal emitted by at least one light source; and
an electronic circuit configured to drive the modulator unit according to a predetermined electric signal such that the QKD transmitter operates either in a CV-QKD mode or in a DV-QKD mode.

17. (canceled)

18. (canceled)

19. (canceled)

20. The QKD transmitter of claim 16, wherein the QKD transmitter of a network node is adapted to communicate with corresponding QKD receiver of at least one other network node of the optical fiber network according to the CV-QKD mode and/or the DV-QKD mode.

21. (canceled)

22. (canceled)

23. A quantum key distribution (QKD) receiver configured to receive information in an optical fiber network, the QKD receiver comprising:
a processing/detection unit configured to perform reception and/or detection of continuous-variable (CV)-QKD and discrete-variable (DV)-QKD signals in a CV-QKD mode and a DV-QKD mode respectively; and
an electronic circuit configured to drive the processing/detection unit according to a predetermined electric signal such that the QKD receiver operates either in the CV-QKD mode or in the DV-QKD mode.

24. (canceled)

25. (canceled)

26. The QKD receiver of claim 23, wherein the QKD receiver of a network node is adapted to communicate with corresponding QKD transmitter of at least one other network node of the optical fiber network according to the CV-QKD mode and/or the DV-QKD mode.

27. (canceled)

28. (canceled)

29. A method of operation of a network node in an optical fiber network, the network node comprising:
a quantum key distribution (QKD) communication unit configured to communicate with another QKD communication unit of at least one other network node of the optical fiber network according to a continuous-variable (CV)-QKD mode and/or a discrete-variable (CV)-QKD mode; and
a control unit configured to control the QKD communication unit to operate in at least one of the CV-QKD mode and the DV-QKD mode,
the method comprising: using the control unit, switching operation of the QKD communication unit between the CV-QKD mode and the DV-QKD mode.
